(19) United States
(12) Patent Application Publication
(10) Pub. No.: US 2026/0301421 A1
(43) Pub. Date: Oct. 1, 2026

(54) STREAMING SYSTEM, STORAGE MEDIUM, AND STREAMING METHOD

(71) Applicant: HONDA MOTOR CO., LTD., Tokyo (JP)

(72) Inventors: Yuta Nishizawa, Tokyo (JP); Kenta Maruyama, Tokyo (JP)

(21) Appl. No.: 19/452,493

(22) Filed: Jan. 19, 2026

(30) Foreign Application Priority Data
Mar. 28, 2025 (JP) 2025-056377

(51) Int. Cl. G06V 20/58; G06F 3/01; G06F 3/14; G06F 3/16; G06V 10/25

(52) U.S. Cl. CPC G06V 20/58; G06F 3/013; G06F 3/14; G06F 3/165; G06V 10/25

(57) ABSTRACT

A streaming system includes: a streaming unit that streams an image obtained through capturing by a capturing apparatus provided in a vehicle; a terminal apparatus that is provided in a location other than the vehicle and displays the streamed image; and an addition unit that adds sound to the image, wherein the addition unit adds external environmental sound of the vehicle based on position information of the vehicle, and the terminal apparatus displays the image and outputs the external environmental sound added to the image.

### INCORPORATION BY REFERENCE

The present application claims priority under 35 U.S.C. § 119 to Japanese Patent Application No. 2025-056377 filed on Mar. 28, 2025. The content of the application is incorporated herein by reference in its entirety.

### BACKGROUND OF THE INVENTION

### Field of the Invention

The present invention relates to a streaming system, a storage medium, and a streaming method.

### Description of the Related Art

In recent years, efforts have been accelerating to provide access to sustainable transportation systems that take into account vulnerable traffic participants such as the elderly, people with disabilities, and children. To this end, efforts are focused on research and development for further improving the safety and convenience of traffic through the development of means of transportation for vulnerable road users. There is a method of viewing a moving image streamed by a streamer of an image (for example, see Japanese Patent Laid-Open No. 2024-039702), without a person in a vulnerable position personally having to enter a mobile body to access a transportation system. Japanese Patent Laid-Open No. 2024-039702 discloses transmitting an image captured by a camera unit provided in a vehicle to an apparatus used at a different location than the vehicle, and transmitting speech inside and outside the vehicle to the apparatus used at the different location than the vehicle.

Sound other than speech can typically be heard inside a vehicle, but Japanese Patent Laid-Open No. 2024-039702 discloses a configuration in which an image and speech are transmitted, but does not take sound other than the speech into consideration. Therefore, in the configuration of Japanese Patent Laid-Open No. 2024-039702, it may be difficult for a viewer of the image transmitted from the vehicle to experience the sensation of riding in the vehicle.

The present invention was made in view of the above-described circumstances and has an object to enable a viewer of an image to more fully experience the sensation of riding in a vehicle. Therefore, through a service for connecting remote locations and vehicles, the present invention contributes to supporting good connection between urban areas and regional areas such as those surrounding urban areas, and to the development of sustainable transportation systems.

### SUMMARY OF THE INVENTION

An aspect of the present invention is a streaming system including: a streaming unit that streams an image obtained through capturing by a capturing apparatus provided in a vehicle; a terminal apparatus that is provided in a location other than the vehicle and displays the streamed image; and an addition unit that adds sound to the image, wherein the addition unit adds external environmental sound of the vehicle based on position information of the vehicle, and the terminal apparatus displays the image and outputs the external environmental sound added to the image.

According to the above aspect of the present invention, a viewer of the image can more fully experience the sensation of riding in the vehicle.

### BRIEF DESCRIPTION OF THE DRAWINGS

FIG. 1 is a diagram showing a system configuration of a streaming system;

FIG. 2 is a diagram showing an attachment example of a streamer terminal in a vehicle;

FIG. 3 is a diagram showing the attachment example of the streamer terminal in the vehicle;

FIG. 4 is a diagram showing a configuration of the vehicle and a streaming server;

FIG. 5 is a diagram showing functional units of a first processor;

FIG. 6 is a diagram for describing a region of interest;

FIG. 7 is a diagram showing a configuration of a user information DB;

FIG. 8 is a diagram showing a configuration of a stream management DB;

FIG. 9 is a block diagram showing a configuration of a viewer terminal;

FIG. 10 shows flowcharts showing an operation of an in-vehicle apparatus, the streaming server, and the viewer terminal; and

FIG. 11 is a flowchart showing an operation of an addition unit.

### DETAILED DESCRIPTION OF THE INVENTION

### 1. Configuration of Streaming System

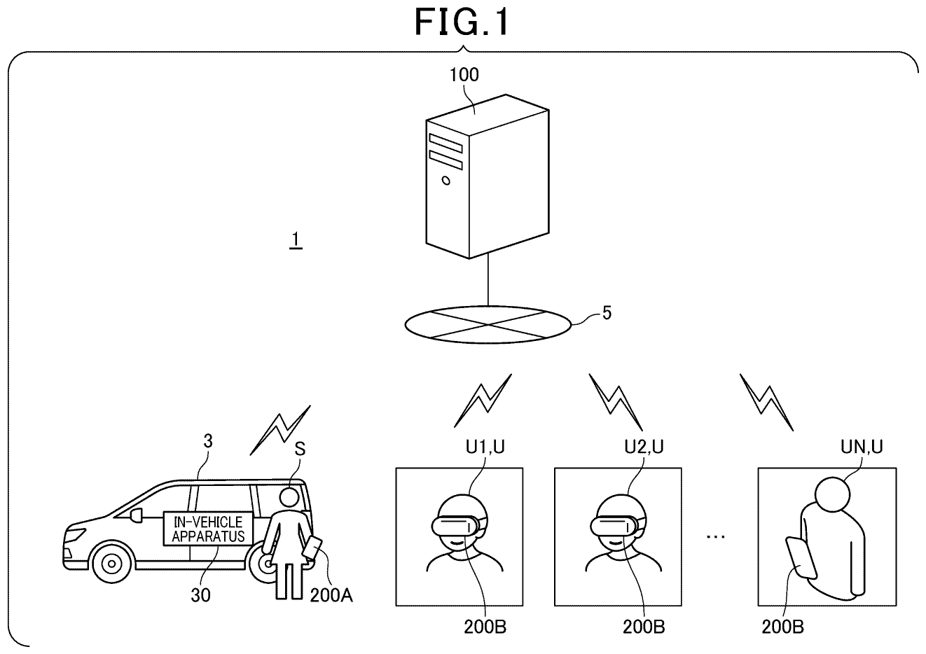

FIG. 1 is a diagram showing a system configuration of a streaming system 1.

The streaming system 1 includes a vehicle 3, a streamer terminal 200A, a streaming server 100, and a viewer terminal 200B. The streaming system 1 is a system for live streaming content including an image obtained through capturing by the streamer terminal 200A.

Live streaming refers to streaming the image obtained through capturing by the streamer terminal 200A to the viewer terminal 200B in real-time. The image may be a still image or a moving image.

The streamer terminal 200A is an example of a “capturing apparatus.” The viewer terminal 200B is an example of a “terminal apparatus.”

An in-vehicle apparatus 30 is installed in the vehicle 3. The in-vehicle apparatus 30 is wirelessly connected via short-range wireless communication or the like to the streamer terminal 200A possessed by a streamer S being an occupant of the vehicle 3. The in-vehicle apparatus 30 receives, from the streamer terminal 200A, the image obtained through capturing by a camera included in the streamer terminal 200A.

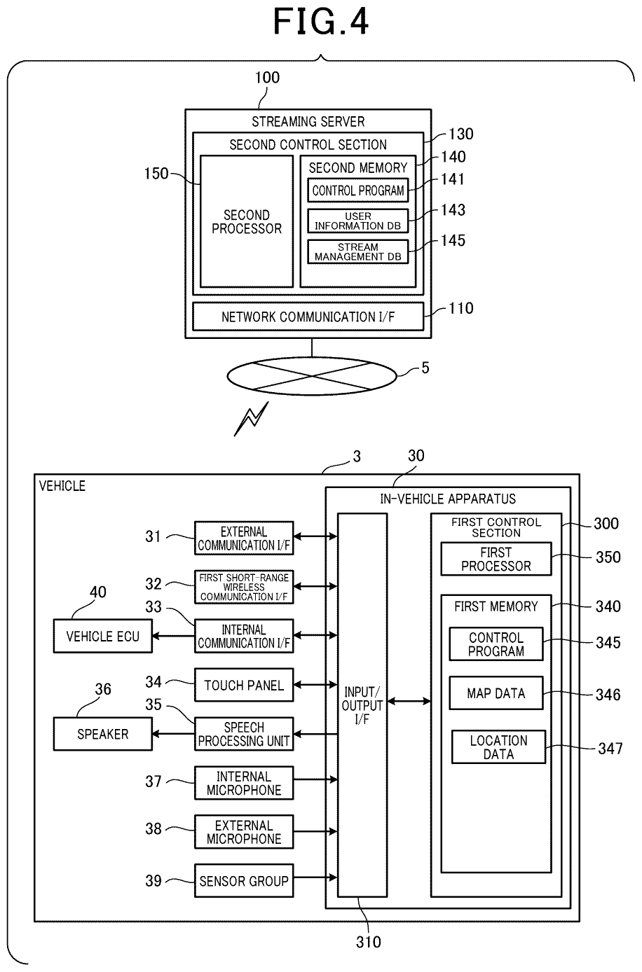

The in-vehicle apparatus 30 receives, from an internal microphone 37 (see FIG. 4), sound collected by the internal microphone 37. Note that the internal microphone 37 is a microphone provided in the vehicle 3.

The in-vehicle apparatus 30 receives, from an external microphone 38 (see FIG. 4), sound collected by the external microphone 38. The external microphone 38 is a microphone provided on an exterior of the vehicle 3.

The in-vehicle apparatus 30 uploads content data including the received image, sound, and the like to the streaming server 100.

The streamer terminal 200A may be a smartphone or tablet personal computer (PC), or may be a camera such as a digital camera or a 360-degree camera capable of capturing an entire surrounding area. Note that when the streamer terminal 200A is a smartphone or tablet PC, the internal microphone 37 may be the streamer terminal 200A.

The streamer terminal 200a is provided in the vehicle 3.

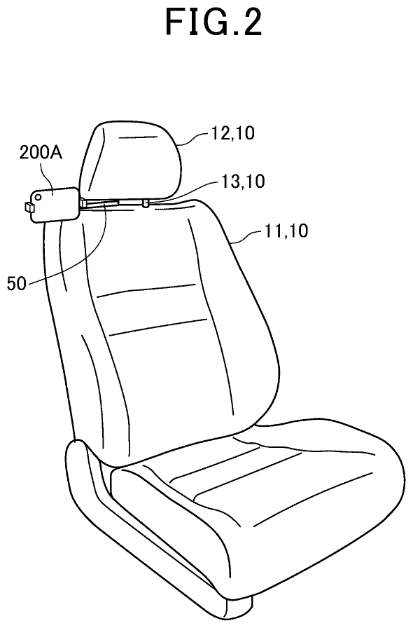

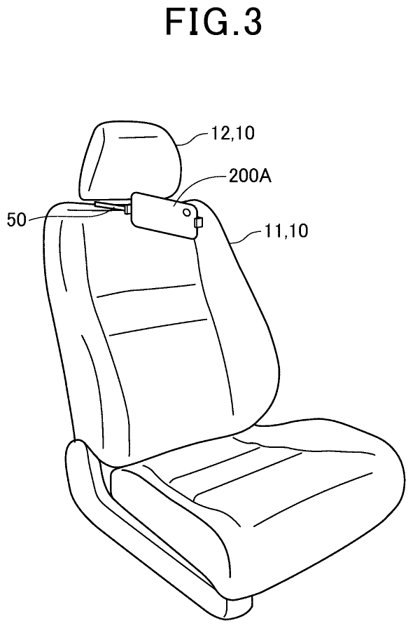

FIGS. 2 and 3 are diagrams showing attachment examples of the streamer terminal 200A in the vehicle 3.

FIGS. 2 and 3 show examples in which the streamer terminal 200A is attached to a passenger seat 10 of the vehicle 3.

The streamer terminal 200A is attached to the seat 10 via an attachment 50. The attachment 50 is attached to a headrest stay 13 that fixes a headrest 12 of the passenger seat 10 to a backrest 11.

FIG. 2 shows an example in which the streamer terminal 200A is attached to the passenger seat 10 so that an area in front of the vehicle 3 is included in an angle of view of the streamer terminal 200A. This attachment position of the streamer terminal 200A is referred to as a first position. FIG. 3 shows an example in which the streamer terminal 200A is attached to the passenger seat 10 so that the streamer S seated in a driver seat is included in the angle of view of the streamer terminal 200A. This attachment position of the streamer terminal 200A is referred to as a second position.

A first holder 51 for fixing the streamer terminal 200A to the attachment 50 is provided at one end portion of the attachment 50 and a second holder for fixing the attachment 50 to the headrest stay 13 is provided at the other end portion of the attachment 50. Illustration of the second holder is omitted. After changing an attachment direction of the attachment 50 to the headrest stay 13, the streamer terminal 200A is attached to the passenger seat 10 in the first position or the second position by fixing the attachment 50 to the headrest stay 13 via the second holder.

Returning to the description of FIG. 1, the streaming server 100 streams content streamed from the vehicle 3 to the viewer terminal 200B of a viewer U. This streaming technology can be realized using known technology such as HTTP Live Streaming (HLS), Common Media Application Format (CMAF), Web Real-Time Communication (WebRTC), or Real-Time Messaging Protocol (RTMP).

The viewer terminal 200B is a terminal apparatus possessed by the viewer U that views the content streamed from the streaming server 100. FIG. 1 shows U1, U2, . . . , UN viewers U as the viewer U. N is an arbitrary natural number.

For example, the viewer terminal 200B may be a portable or mobile terminal apparatus such as a smartphone, a tablet PC, or a notebook PC, or may be a stationary terminal apparatus such as a desktop PC. The viewer terminal 200B may be a television set, or a head-mounted display apparatus in which an image display part is mounted on the head of the viewer U and a display included in the image display part is arranged in front of the eyes of the viewer U. The head-mounted display apparatus may be transmissive or non-transmissive, as long as the content streamed from the streaming server 100 can be viewed.

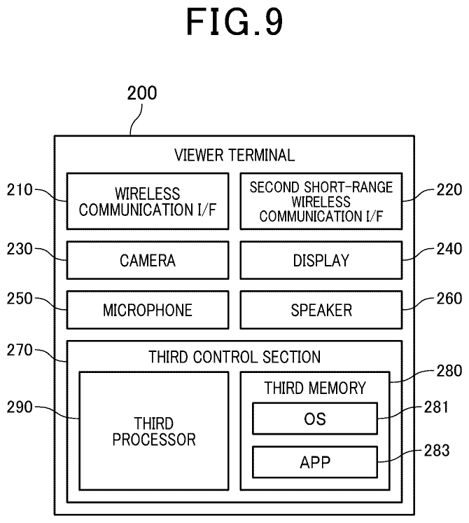

The viewer terminal 200B includes a display 240 (see FIG. 9) and a speaker 260 (see FIG. 9), displays an image streamed from the streaming server 100 on the display 240, and outputs speech streamed from the streaming server 100 via the speaker 260.

The viewer terminal 200B includes a microphone 250 (see FIG. 9) and uploads speech data of the viewer U collected by the microphone 250 to the streaming server 100. The streaming server 100 transmits the uploaded speech data of the viewer U to the in-vehicle apparatus 30. The in-vehicle apparatus 30 then outputs the speech indicated by the received speech data of the viewer U in the vehicle 3 via a speaker 36 (see FIG. 4). With this, the viewer U and the streamer S can converse during streaming of the content.

The viewer terminal 200B includes a camera 230 (see FIG. 9), and detects a line of sight direction of the viewer U toward the image displayed on the display 240 from an image obtained through capturing by the camera 230. Upon detecting the line of sight direction of the viewer U, the viewer terminal 200B uploads line of sight direction data indicating the detected line of sight direction to the streaming server 100. The streaming server 100 transmits the uploaded line of sight direction data to the in-vehicle apparatus 30.

A communication network 5 is a wired or wireless transmission path for information transmitted from an apparatus connected to the communication network 5. For example, the communication network 5 may include a public network such as the Internet, a mobile communication network, a satellite communication network, or various local area networks (LANs) including Ethernet (registered trademark) or a wide area network (WAN). The communication network 5 may include a dedicated network such as an Internet protocol-virtual private network (IP-VPN).

### 2. Configuration of Vehicle

FIG. 4 is a diagram showing a configuration of the vehicle 3 and the streaming server 100.

First, the configuration of the vehicle 3 will be described with reference to FIG. 4.

The vehicle 3 includes the in-vehicle apparatus 30, an external communication interface 31, a first short-range wireless communication interface 32, an internal communication interface 33, a touch panel 34, a speech processing unit 35, the speaker 36, the internal microphone 37, the external microphone 38, and a sensor group 39. Hereinafter, interface will be abbreviated as I/F.

First, the external communication interface 31, the first short-range wireless communication interface 32, the internal communication interface 33, the touch panel 34, the speech processing unit 35, the speaker 36, the internal microphone 37, the external microphone 38, and the sensor group 39 will be described.

The external communication I/F 31 is a communication module that performs wireless communication in accordance with a mobile communication standard such as long-term evolution (LTE), fourth-generation (4G), 5G, or Wi-Fi (registered trademark). The external communication I/F 31 is connected to the communication network 5 via an antenna (not shown) and performs mutual data transmission/reception with the streaming server 100. Note that the external communication I/F 31 is, for example, a telematics control unit (TCU).

For example, the first short-range wireless communication I/F 32 is a communication apparatus that performs wireless communication in accordance with a short-range wireless communication standard such as Bluetooth (registered trademark) or Wi-Fi. For example, the first short-range wireless communication I/F 32 is a communication module that performs communication in accordance with a near-field communication (NFC) standard such as Bluetooth or Wi-Fi. The first short-range wireless communication I/F 32 performs short-range wireless communication with a terminal apparatus possessed by an occupant and receives an image, speech, and the like captured by the terminal apparatus.

The internal communication I/F 33 is an input/output interface connected to an in-vehicle network (not shown). For example, a communication bus supporting a communication standard such as controller area network (CAN), CAN with Flexible Data-Rate (CAN FD), or Ethernet is used for the in-vehicle network. The internal communication I/F 33 performs mutual data communication via the in-vehicle network with in-vehicle equipment such as a vehicle ECU 40 or another relay apparatus.

The touch panel 34 includes a display panel such as a liquid-crystal panel or an organic electroluminescent (EL) panel, and a touch sensor. The touch sensor detects a touch operation by the viewer U on the touch panel 34 and outputs position information indicating a position of the detected touch operation to a first control section 330.

For example, the speech processing unit 35 includes a processor and converts digital speech data output by the first control section 330 into an analog speech signal. The speech processing unit 35 amplifies the converted analog speech signal and outputs the amplified speech signal via the speaker 36.

The internal microphone 37 is provided at a predetermined position inside the vehicle 3, and collects internal environmental sound of the vehicle 3 (hereinafter, notated as “internal environmental sound” as appropriate). When the streamer S speaks inside the vehicle 3, the internal environmental sound includes the speech of the streamer S. The internal microphone 37 outputs data of the collected internal environmental sound to the in-vehicle apparatus 30.

The external microphone 38 is provided on the exterior of the vehicle 3, and collects external environmental sound of the vehicle 3 (hereinafter, notated as “external environmental sound” as appropriate). The external microphone 38 outputs data of the collected external environmental sound to the in-vehicle apparatus 30.

In the present embodiment, the vehicle 3 includes a plurality of external microphones 38. In the present embodiment, each external microphone 38 is provided at a different location on the exterior of the vehicle 3. For example, the external microphone 38 is provided on the exterior of the vehicle 3 at locations such as a front right of the vehicle 3, a front center of the vehicle 3, a front left of the vehicle 3, a right side of the vehicle 3, a left side of the vehicle 3, a rear right of the vehicle 3, and a rear left of the vehicle 3. More specifically, in the present embodiment, the external microphone 38 is provided at a location corresponding to a region of interest that is identifiable by an identification unit 354. Each of the identification unit 354 and the region of interest will be described below.

The sensor group 39 includes various sensors. The sensor group 39 of the present embodiment includes an acceleration sensor, a vehicle speed sensor, a global navigation satellite system (GNSS) unit, and a raindrop sensor.

The acceleration sensor is a sensor that detects an acceleration of the vehicle 3. The acceleration sensor detects the acceleration of the vehicle 3 at predetermined intervals and outputs a detected value to the in-vehicle apparatus 30 every time the acceleration sensor detects the acceleration of the vehicle 3.

The vehicle speed sensor is a sensor that detects a speed of the vehicle 3. The vehicle speed sensor detects the speed of the vehicle 3 at predetermined intervals and outputs a detected value to the in-vehicle apparatus 30 every time the vehicle speed sensor detects the speed of the vehicle 3.

The GNSS unit measures a current position of the vehicle 3. The GNSS unit generates position data indicating the current position of the vehicle 3 and outputs the generated position data to the in-vehicle apparatus 30.

The raindrop sensor is, for example, a sensor that is provided on a windshield of the vehicle 3 and detects raindrops. The raindrop sensor outputs a detection result to the in-vehicle apparatus 30.

Raindrops are an example of a “target object.”

The in-vehicle apparatus 30 includes an input/output I/F 310 and the first control section 330.

The input/output I/F 310 functions as a connection unit between the first control section 330 and the external communication I/F 31, the first short-range wireless communication I/F 32, the internal communication I/F 33, the touch panel 34, the speech processing unit 35, the internal microphone 37, the external microphone 38, and the sensor group 39. The input/output I/F 310 includes a connector and an interface circuit. The input/output I/F 310 outputs data input from the external communication I/F 31, the first short-range wireless communication I/F 32, the internal communication I/F 33, the touch panel 34, the speech processing unit 35, the internal microphone 37, the external microphone 38, and the sensor group 39 to the first control section 330. The input/output I/F 310 outputs data input from the first control section 330 to the external communication I/F 31, the first short-range wireless communication I/F 32, the internal communication I/F 33, the touch panel 34, and the speech processing unit 35.

The first control section 330 is a computer apparatus including a first memory 340 and a first processor 350.

The first processor 350 is an example of a “processor.”

The first memory 340 includes, for example, a volatile semiconductor memory and a non-volatile semiconductor memory. The first memory 340 may include only a non-volatile semiconductor memory. The first memory 340 may include an auxiliary storage apparatus such as a solid-state drive (SSD). The first memory 340 stores a control program 345 executed by the first processor 350, map data 346, location data 347, configuration data that defines an operation of the in-vehicle apparatus 30, and the like.

The control program 345 is an example of a “program.”

The map data 346 is data including road map information, building information, and the like. The road map information includes information relating to a road network in which roads on a map are represented by lines, intersections and junctions are divided into a plurality of portions as nodes, and portions between each node are specified as links. The building information indicates a position of a building, a name of the building, a shape of the building when viewed from above, and the like.

The location data 347 is data in which locations are recorded to which the external environmental sound is added by the addition unit 355 to be described below. The locations recorded in the location data 347 are predetermined.

The first processor 350 is, for example, an arithmetic processing apparatus such as a central processing unit (CPU) or a microprocessing unit (MPU). The first processor 350 may be implemented as a single processor or as a plurality of processors. The first processor 350 may be implemented as a system on a chip (SoC) integrated with part or all of the first memory 340, or with another circuit.

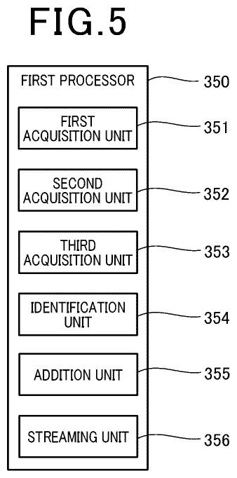

FIG. 5 is a diagram showing functional units of the first processor 350.

The first processor 350 functions as a first acquisition unit 351, a second acquisition unit 352, a third acquisition unit 353, the identification unit 354, the addition unit 355, and a streaming unit 356 by loading and executing the control program 345 stored in the first memory 340.

### [2-1. First Acquisition Unit]

The first acquisition unit 351 acquires the external environmental sound via the external microphone 38. The first acquisition unit 351 outputs the data of the acquired external environmental sound to the addition unit 355.

### [2-2. Second Acquisition Unit]

The second acquisition unit 352 acquires the internal environmental sound via the internal microphone 37. The second acquisition unit 352 outputs the data of the acquired internal environmental sound to the third acquisition unit 353 and the addition unit 355.

### [2-3. Third Acquisition Unit]

The third acquisition unit 353 acquires conversation content between the viewer U and the streamer S during streaming of the content. The third acquisition unit 353 acquires the conversation content between the viewer U and the streamer S as text data, by performing speech recognition on the internal environmental sound acquired by the second acquisition unit 352 and the speech of the viewer U transmitted from the streaming server 100. Note that the speech recognition is performed using an existing technology with reference to an acoustic model, a language model, or the like. The third acquisition unit 353 outputs the text data indicating the acquired conversation content to the addition unit 355.

### [2-4. Identification Unit]

The identification unit 354 identifies the region of interest based on the line of sight direction of the viewer U during streaming of the content. The region of interest refers to a region in the streamed image that the viewer U is paying attention to. The identification unit 354 identifies, as the region of interest, a region in the image to which the line of sight direction of the viewer U is continuously directed for a predetermined amount of time, based on the line of sight direction data transmitted from the streaming server 100.

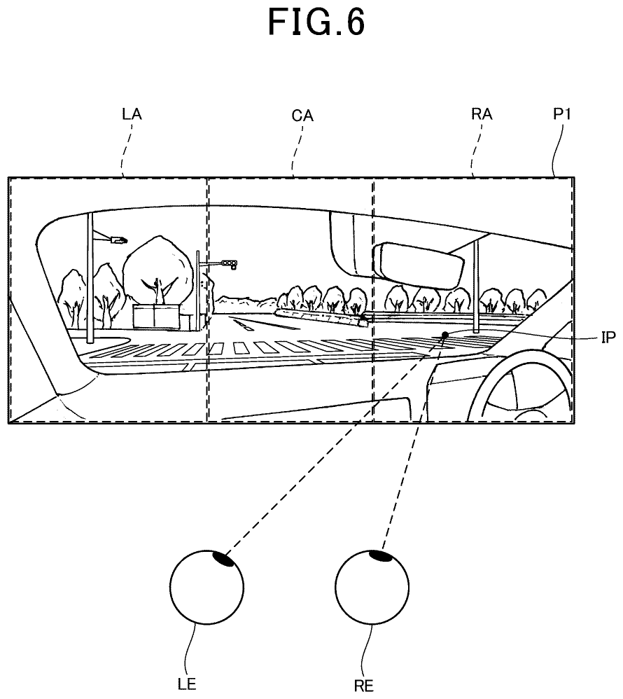

FIG. 6 is a diagram for describing the region of interest.

FIG. 6 exemplifies a case in which the viewer U is viewing an image P1. The image P1 shown in FIG. 6 is an image captured from the passenger seat of the vehicle 3 and depicts the area in front of the vehicle 3 through the windshield. Note that in FIG. 6, a target marked with reference sign “LE” is the left eye and a target marked with the reference sign “RE” is the right eye.

FIG. 6 exemplifies a case in which the identification unit 354 identifies one region of interest from among a first region LA, a second region CA, and a third region RA.

FIG. 6 exemplifies a case in which the line of sight direction of the viewer U is directed to the right in the image P1 and a viewpoint IP is within the right-side third region RA. Thus, in the example of FIG. 6, the identification unit 354 identifies that the region of interest is the right-side third region RA in the image P1. The identification unit 354 knows which direction the line of sight direction is and which region among the first region LA, the second region CA, and the third region RA the viewpoint IP is located in. Therefore, in the example of FIG. 6, the identification unit 354 identifies that the region of interest is the third region RA, as described above.

When the line of sight direction of the viewer U is directed to the left in the image P1 and the viewpoint IP is within the left-side first region LA, the identification unit 354 identifies that the region of interest is the left-side first region LA in the image P1. When the line of sight direction of the viewer U is directed to approximately the longitudinal center of the image P1 and the viewpoint IP is within the second region CA, the identification unit 354 identifies that the region of interest is the second region CA interposed between the first region LA and the third region RA.

Note that FIG. 6 is merely an example for describing the identifying of the region of interest. Thus, the identification unit 354 may be capable of identifying the region of interest from four or more regions or may identify the region of interest from a left-side region and a right-side region. However, the external microphone 38 is preferably provided on the exterior of the vehicle depicted in the region of interest that is identifiable by the identification unit 354.

Upon identifying the region of interest, the identification unit 354 outputs data indicating the identified region of interest to the addition unit 355.

### [2-5. Addition Unit]

The addition unit 355 adds sound to the image obtained through capturing by the streamer terminal 200A. The addition unit 355 of the present embodiment adds at least one of the internal environmental sound, the external environmental sound, or vehicle-related sound. The vehicle-related sound is sound related to the vehicle 3, examples of which include engine sound, turn signal sound, and tire running sound. The turn signal sound is sound emitted when a direction indicator is operated.

### [2-5-1. Addition of Internal Environmental Sound]

First, addition of the internal environmental sound will be described.

When the second acquisition unit 352 has acquired the internal environmental sound, the addition unit 355 adds the internal environmental sound acquired by the second acquisition unit 352. Note that the second acquisition unit 352 acquiring the internal environmental sound refers to the second acquisition unit 352 acquiring internal environmental sound at a predetermined volume or louder.

### [2-5-2. Addition of External Environmental Sound Based on Position Information of Vehicle]

Next, addition of the external environmental sound will be described.

The addition unit 355 adds the external environmental sound based on position information of the vehicle 3. The addition unit 355 identifies a location corresponding to the current position of the vehicle 3 based on the position information of the vehicle 3 detected by the GNSS unit of the sensor group 39 and the map data 346. Subsequently, the addition unit 355 determines whether the identified location is recorded in the location data 347, and adds the external environmental sound acquired by the first acquisition unit 351 when the identified location is recorded in the location data 347.

Note that the addition unit 355 may add external environmental sound stored in the first memory 340.

In the case of this configuration, the location data 347 includes data of appropriate external environmental sound per location. For example, the location data 347 stores “sound of waves” data for a location “seaside road.” For example, the location data 347 stores “bird chirping” data, “rustling leaves sound” data, “cold wintry wind sound” data, “waterfall sound” data, or the like for a location “in the mountains.” For example, the location data 347 stores “traffic signal sound” data for a location “intersection.” For example, the location data 347 stores “downtown noise” data for a location “downtown.”

In the case of this configuration, for example, when the identified location is a seaside road, the addition unit 355 adds the sound of waves as the external environmental sound. For example, when the identified location is in the mountains, the addition unit 355 adds the bird chirping, the rustling leaves sound, the cold wintry wind sound, the waterfall sound, or the like as the external environmental sound. For example, when the identified location is an intersection, the addition unit 355 adds the traffic signal sound as the external environmental sound. For example, when the identified location is downtown, the addition unit 355 adds the downtown noise as the external environmental sound.

### [2-5-2. Addition of External Environmental Sound When Raining]

When it is raining outside of the vehicle 3, the addition unit 355 adds the sound of rain as the external environmental sound. More specifically, when the raindrop sensor of the sensor group 39 detects raindrops, the addition unit 355 adds the sound of rain as the external environmental sound. Note that the sound of rain added by the addition unit 355 may include sound produced when rain hits a body of the vehicle 3 or may include sound produced when rain hits the ground.

The sound of rain is an example of “target object-related sound.”

The addition unit 355 may add the sound of rain based on sound of rain data stored in the first memory 340 or may add the external environmental sound acquired by the first acquisition unit 351 as the sound of rain.

Note that when it is raining outside of the vehicle 3, the addition unit 355 may add splashing water sound as the external environmental sound together with or instead of the sound of rain. The splash water sound is sound emitted when the vehicle 3 passes through a puddle of water. In this case, the addition unit 355 adds the water splashing sound using water splashing sound data stored in the first memory 340.

### [2-5-3. Addition of Vehicle-Related Sound]

Next, addition of the vehicle-related sound will be described.

The addition unit 355 adds the engine sound based on vehicle information relating to the vehicle 3 during driving.

For example, the addition unit 355 acquires the detected value from the acceleration sensor of the sensor group 39 as the vehicle information relating to the vehicle 3 during driving, and adds the engine sound when the acquired detected value indicates an increase in acceleration.

For example, the addition unit 355 acquires the detected value from the vehicle speed sensor of the sensor group 39 as the vehicle information relating to the vehicle 3 during driving, and adds the engine sound when the acquired detected value indicates an increase in speed.

The engine sound is stored in the first memory 340, and the addition unit 355 adds the engine sound stored in the first memory 340.

The addition unit 355 adds the turn signal sound based on the vehicle information relating to the vehicle 3 during driving. The addition unit 355 acquires, from a predetermined sensor, information indicating whether the direction indicator has been operated as the vehicle information relating to the vehicle 3 during driving. When the information indicating that the direction indicator has been operated is acquired, the addition unit 355 adds the turn signal sound.

Turn signal sound data is stored in the first memory 340, and the addition unit 355 adds the turn signal sound stored in the first memory 340.

The addition unit 355 adds the tire running sound based on the vehicle information relating to the vehicle 3 during driving.

For example, the addition unit 355 acquires the detected value from the acceleration sensor of the sensor group 39 as the vehicle information relating to the vehicle 3 during driving, and adds the tire running sound when the acquired detected value indicates an increase in acceleration.

For example, the addition unit 355 acquires the detected value from the vehicle speed sensor of the sensor group 39 as the vehicle information relating to the vehicle 3 during driving, and adds the tire running sound when the acquired detected value indicates an increase in speed.

Tire running sound data is stored in the first memory 340, and the addition unit 355 adds the tire running sound stored in the first memory 340.

### [2-5-3. Volume Settings for Sound to be Added]

The addition unit 355 sets the volume of sound to be added to the image obtained through capturing by the streamer terminal 200A.

When adding the internal environmental sound and the external environmental sound, the addition unit 355 sets the internal environmental sound to be added to a higher volume than the external environmental sound to be added.

When adding the external environmental sound without adding the internal environmental sound and if the second acquisition unit 352 has not acquired the internal environmental sound for a predetermined amount of time or longer, the addition unit 355 sets the external environmental sound to be added to a higher volume than the external environmental sound when adding the internal environmental sound.

The addition unit 355 sets the volume of the external environmental sound to be added, based on the region of interest identified by the identification unit 354. More specifically, the addition unit 355 sets the external environmental sound corresponding to the region of interest identified by the identification unit 354 to a higher volume than the external environmental sound corresponding to a region other than the region of interest identified by the identification unit 354.

For example, the region of interest identified by the identification unit 354 is the third region RA shown in the example of FIG. 6. In the case of the example of FIG. 6, the addition unit 355 sets the external environmental sound collected by the external microphone 38 provided at the front right of the vehicle 3 to a higher volume than the external environmental sound collected by microphones other than the external microphone 38, and adds the external environmental sound to the image P1.

The addition unit 355 sets the volume of the sound to be added, based on the conversation content acquired by the third acquisition unit 353. Note that the addition unit 355 recognizes the conversation content through text analysis.

For example, when the conversation content acquired by the third acquisition unit 353 is content relating to “weather” and the sound of rain is to be added, the addition unit 355 sets the sound of rain to be added to a higher volume than the sound of rain when the conversation content is not content relating to “weather.”

For example, when the conversation content acquired by the third acquisition unit 353 is content relating to “scenery” and the external environmental sound is to be added based on the position information of the vehicle 3, the addition unit 355 sets the external environmental sound to be added to a higher volume than the external environmental sound to be added when the conversation content is not content relating to “scenery.”

For example, when the conversation content acquired by the third acquisition unit 353 is content relating to “cars” and the vehicle-related sound is to be added, the addition unit 355 sets the vehicle-related sound to be added to a higher volume than the vehicle-related sound to be added when the conversation content is not content relating to “cars.”

### [2-6. Streaming Unit]

The streaming unit 356 streams the image to which the sound has been added by the addition unit 355 to the viewer terminal 200B via the external communication I/F 31. More specifically, the streaming unit 356 uploads, to the streaming server 100 via the external communication I/F 31, content data including the image to which the sound has been added by the addition unit 355 along with a stream identification (ID).

### 3. Configuration of Streaming Server

Next, the configuration of the streaming server 100 will be described with reference to FIG. 4.

The streaming server 100 includes a network communication I/F 110 and a second control section 130.

For example, the network communication I/F 110 includes a communication card such as a network interface card (NIC), and performs mutual data communication via the communication network 5 with the vehicle 3, the viewer terminal 200B, and the like.

The second control section 130 is a computer apparatus including a second memory 140 and a second processor 150.

The second memory 140 includes, for example, a volatile semiconductor memory and a non-volatile semiconductor memory. The second memory 140 may include only a non-volatile semiconductor memory. The second memory 140 may include an auxiliary storage apparatus such as a hard disk drive (HDD) or an SSD.

The second memory 140 stores a control program 141 executed by the second processor 150, a user information database 143, and a stream management database 145. Hereinafter, database will be abbreviated as DB.

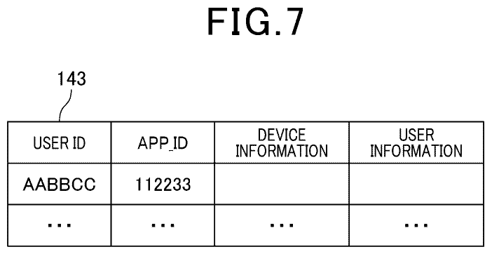

FIG. 7 is a diagram showing a configuration of the user information DB 143.

One record in the user information DB 143 includes a user ID, APP_ID, device information, and user information. APP is an abbreviation of application program.

The user ID is identification information for identifying a user utilizing a streaming service provided by the streaming server 100. The user includes the streamer S and the viewer U.

APP_ID is identification information for identifying an application program downloaded on the streamer terminal 200A or the viewer terminal 200B.

The streamer S and the viewer U download the APP from a predetermined website and respectively install the APP on the streamer terminal 200A and the viewer terminal 200B.

The device information is information related to the viewer terminal 200B. The device information is, for example, information indicating whether the viewer terminal 200B is a smartphone, a PC, a head-mounted display apparatus, or a camera. For example, a model number is used for the device information. The device information includes communication information for communicating with the viewer terminal 200B. Note that an example of this communication information includes address information.

The user information is personal information of the streamer S and the viewer U being the user. The user information includes, for example, information such as name, address, sex, and age.

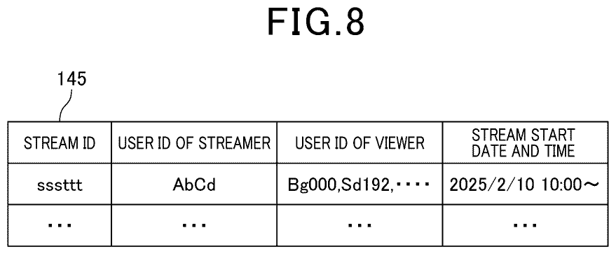

FIG. 8 is a diagram showing a configuration of the stream management DB 145.

One record in the stream management DB 145 includes a stream ID for identifying a stream, the user ID of the streamer S, the user ID of the viewer U, and a stream start date and time.

Returning to FIG. 4, the configuration of the streaming server 100 will be described further.

The second processor 150 is, for example, an arithmetic processing apparatus such as a CPU or an MPU. The second processor 150 may be implemented as a single processor or as a plurality of processors. The second processor 150 may be implemented as an SoC integrated with part or all of the second memory 140, or with another circuit.

The second control section 130 executes various operations by the second processor 150 loading and executing the control program 141.

### 4. Configuration of Viewer Terminal

FIG. 9 is a block diagram showing a configuration of the viewer terminal 200B.

The viewer terminal 200B includes a wireless communication I/F 210, a second short-range wireless communication I/F 220, the camera 230, the display 240, the microphone 250, the speaker 260, and a third control section 270.

The wireless communication I/F 210 is a communication module that performs wireless communication in accordance with a mobile communication standard such as LTE, 4G, 5G, or Wi-Fi. The wireless communication I/F 210 is connected to the communication network 5 via an antenna (not shown) and performs mutual data transmission/reception with the streaming server 100.

For example, the second short-range wireless communication I/F 220 is a communication module that performs communication in accordance with an NFC standard such as Bluetooth or Wi-Fi. The second short-range wireless communication I/F 220 transmits a captured image captured by the camera 230, speech input via the microphone 250, and the like to the in-vehicle apparatus 30 through short-range wireless communication with the in-vehicle apparatus 30.

The camera 230 is a capturing apparatus including an image sensor and a data processing circuit. The image sensor is implemented as, for example, a charge-coupled device (CCD) or a complementary metal-oxide-semiconductor (CMOS). The data processing circuit generates a captured image from an output of the image sensor. A captured range of the camera 230 is set to a range including the eyes of the viewer U that is viewing the content. The captured image generated by the camera 230 is output to the third control section 270.

The microphone 250 is a speech input apparatus for inputting speech of the streamer S, the viewer U, and the like. The speaker 260 is a speech output apparatus for outputting speech of the streamer S, the viewer U, and the like.

The display 240 includes a display panel such as a liquid-crystal panel or an organic EL panel, and a touch sensor. The display 240 functions as a display part for displaying an image and as a reception part for accepting an operation by the streamer S, the viewer U, and the like.

The third control section 270 is a computer apparatus including a third memory 280 and a third processor 290.

The third memory 280 includes a non-volatile semiconductor memory. The third memory 280 may include an auxiliary storage apparatus such as an SD card. The third memory 280 stores control programs such as an operating system (OS) 281 and an APP 283. The APP 283 is an application program that performs mutual data communication with the streaming server 100, displays an image included in content streamed by the streaming server 100 on the display 240, and outputs speech included in the content to the speaker 260.

The third processor 290 is, for example, an arithmetic processing apparatus such as a CPU or an MPU. The third processor 290 may be implemented as a single processor or as a plurality of processors.

The third control section 270 communicates with the streaming server 100 via the wireless communication I/F 210 by the third processor 290 loading and executing the APP 283.

The third control section 270 displays the image included in the content streamed by the streaming server 100 on the display 240 by the third processor 290 loading and executing the APP 283.

The third control section 270 outputs the speech included in the content streamed by the streaming server 100 from the speaker 260 by the third processor 290 loading and executing the APP 283.

The third control section 270 detects the line of sight direction of the viewer U that is watching the content and uploads the line of sight direction data indicating the detected line of sight direction to the streaming server 100, by the third processor 290 loading and executing the APP 283.

### 5. Operation

Next, an operation of each unit of the streaming system 1 according to the present embodiment will be described.

First, the operation of each unit of the streaming system 1 during streaming of the content will be described.

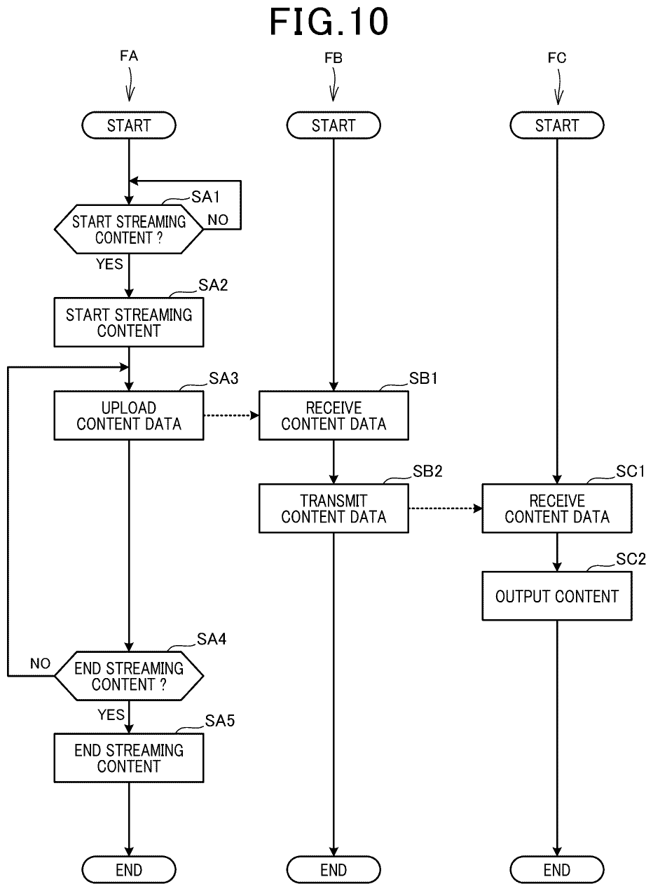

FIG. 10 shows flowcharts showing an operation of the in-vehicle apparatus 30, the streaming server 100, and the viewer terminal 200B. In FIG. 10, a flowchart FA indicates the operation of the in-vehicle apparatus 30, a flowchart FB indicates the operation of the streaming server 100, and a flowchart FC indicates the operation of the viewer terminal 200B.

As shown in the flowchart FA, the streaming unit 356 determines whether to start streaming the content (step SA1).

For example, when the touch panel 34 receives a streaming start instruction, the streaming unit 356 makes a positive determination in step SA1.

For example, when the in-vehicle apparatus 30 receives streaming start information from the streamer terminal 200A, the streaming unit 356 makes the positive determination in step SA1. Note that the streaming start information is information indicating the start of streaming.

When determining to start streaming the content (YES in step SA1), the streaming unit 356 starts streaming the content (step SA2). Upon starting streaming of the content, the streaming unit 356 uploads the content data at predetermined intervals to the streaming server 100 (step SA3).

Step SA3 is an example of a “streaming step.”

As shown in the flowchart FB, the second control section 130 of the streaming server 100 receives the content data from the in-vehicle apparatus 30 (step SB1).

Subsequently, the second control section 130 of the streaming server 100 transmits the received content data to the viewer terminal 200B (step SB2).

Step SB2 will be described in detail below. The second control section 130 identifies a record including the stream ID received together with the content data from the stream management DB 145 and acquires the user ID of the viewer U from the identified record. Subsequently, the second control section 130 acquires the device information per acquired user ID of the viewer U. The second control section 130 then transmits the received content data, based on the communication information included in the acquired device information.

As shown in the flowchart FC, the third control section 270 of the viewer terminal 200B receives the content data from the streaming server 100 (step SC1).

Subsequently, the third control section 270 displays the image included in the content indicated by the received content data on the display 240 and outputs the speech included in the content indicated by the received content data via the speaker 260 (step SC2).

Step SC2 is an example of a “display step.”

Returning to the description of the flowchart FA, the streaming unit 356 determines whether to end streaming the content (step SA4).

For example, when the touch panel 34 receives a streaming end instruction, the streaming unit 356 makes a positive determination in step SA4.

For example, when the in-vehicle apparatus 30 receives streaming end information from the streamer terminal 200A, the streaming unit 356 makes the positive determination in step SA4. Note that the streaming end information is information indicating the end of streaming.

When determining not to end streaming the content (NO in step SA4), the streaming unit 356 returns the processing to step SA3 and performs the processing from step SA3 onward once more. Note that the streaming unit 356 continues streaming the content until a positive determination is made in step SA4.

On the other hand, when determining to end streaming the content (YES in step SA4), the streaming unit 356 ends streaming the content (step SA5).

As described above, the sound is added by the addition unit 355 to the image to be streamed to the viewer terminal 200B, that is, the image obtained through capturing by the streamer terminal 200A.

Next, the operation of the addition unit 355 will be described.

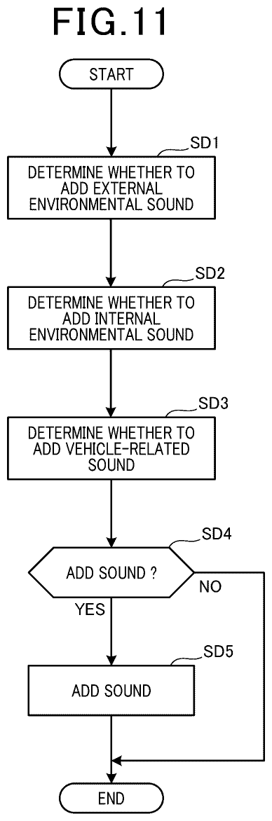

FIG. 11 is a flowchart showing the operation of the addition unit 355. The operation in FIG. 11 is repeatedly executed during streaming of the content.

The addition unit 355 determines whether to add the external environmental sound (step SD1).

Step SD1 will be described in detail below.

The addition unit 355 identifies the location corresponding to the current position of the vehicle 3 based on the position information of the vehicle 3 detected by the GNSS unit of the sensor group 39 and the map data 346. Subsequently, the addition unit 355 determines whether the identified location is recorded in the location data 347. When the identified location is recorded in the location data 347, the addition unit 355 then determines to add the external environmental sound in step SD1.

When the raindrop sensor of the sensor group 39 detects raindrops, the addition unit 355 determines to add the external environmental sound in step SD1.

On the other hand, when the identified location is not recorded in the location data 347 and the raindrop sensor of the sensor group 39 has not detected raindrops, the addition unit 355 determines not to add the external environmental sound in step SD1.

Subsequently, the addition unit 355 determines whether to add the internal environmental sound (step SD2).

Step SD2 will be described in detail below.

The addition unit 355 determines to add the internal environmental sound in step SD2 when the second acquisition unit 352 has acquired the internal environmental sound, and determines not to add the internal environmental sound in step SD2 when the second acquisition unit 352 has not acquired the internal environmental sound.

Subsequently, the addition unit 355 determines whether to add the vehicle-related sound (step SD3).

Step SD3 will be described in detail below.

The addition unit 355 determines not to add the vehicle-related sound in step SD2 when a trigger to add the vehicle-related sound has not occurred, and determines to add the vehicle-related sound in step SD2 when the trigger has occurred.

Note that the trigger to add the vehicle-related sound includes, for example, the acceleration of the vehicle 3 increasing, the speed of the vehicle 3 increasing, or acquiring information indicating that the direction indicator has been operated.

Subsequently, the addition unit 355 determines whether to add the sound to the image to be streamed, based on determination results of steps SD1 to SD3 (step SD4).

When determining not to add the sound to the image to be streamed (NO in step SD4), the addition unit 355 does not add the external environmental sound, the internal environmental sound, and the vehicle-related sound to the image to be streamed.

When determining to add the sound to the image to be streamed (YES in step SD4), the addition unit 355 adds the sound to the image to be streamed (step SD5).

Step SD5 is an example of an “addition step.”

Step SD5 will be described in detail below.

The type of sounds added in step SD5 totals to seven patterns.

### First Pattern

A first pattern is a pattern in which the sound to be added is only the external environmental sound.

In the first pattern, the addition unit 355 adds the external environmental sound to the image to be streamed.

In the first pattern, when the identification unit 354 has identified the region of interest, the addition unit 355 sets, among a plurality of external environmental sounds to be added, the external environmental sound corresponding to the region of interest to a higher volume than the external environmental sound corresponding to a region other than the region of interest.

In the first pattern, when the second acquisition unit 352 has not acquired the internal environmental sound for the predetermined amount of time or longer, the addition unit 355 sets the external environmental sound to be added to a higher volume than the external environmental sound when adding the internal environmental sound.

### Second Pattern

A second pattern is a pattern in which the sound to be added is only the internal environmental sound.

In the second pattern, the addition unit 355 adds the internal environmental sound to the image obtained through capturing by the streamer terminal 200A.

### Third Pattern

A third pattern is a pattern in which the sound to be added is only the vehicle-related sound.

In the third pattern, the addition unit 355 adds the vehicle-related sound to the image obtained through capturing by the streamer terminal 200A.

### Fourth Pattern

A fourth pattern is a pattern in which the sound to be added is the external environmental sound and the internal environmental sound.

In the fourth pattern, the addition unit 355 sets the internal environmental sound to a higher volume than the external environmental sound, and adds the internal environmental sound and the external environmental sound.

In the fourth pattern, when the identification unit 354 has identified the region of interest, the addition unit 355 sets, among the plurality of external environmental sounds to be added, the external environmental sound corresponding to the region of interest to a higher volume than the external environmental sound corresponding to a region other than the region of interest.

In the fourth pattern, when the conversation content acquired by the third acquisition unit 353 is content related to the external environmental sound such as “weather” or “scenery,” the addition unit 355 sets the external environmental sound to be added to a higher volume than the external environmental sound to be added when the conversation content is not content related to the external environment.

### Fifth Pattern

A fifth pattern is a pattern in which the sound to be added is the external environmental sound and the vehicle-related sound.

In the fifth pattern, when the identification unit 354 has identified the region of interest, the addition unit 355 sets, among the plurality of external environmental sounds to be added, the external environmental sound corresponding to the region of interest to a higher volume than the external environmental sound corresponding to a region other than the region of interest.

In the fifth pattern, the addition unit 355 may set the external environmental sound to a higher volume than the vehicle-related sound and add the external environmental sound and the vehicle-related sound, or may set the vehicle-related sound to a higher volume than the external environmental sound and add the external environmental sound and the vehicle-related sound.

### Sixth Pattern

A sixth pattern is a pattern in which the sound to be added is the internal environmental sound and the vehicle-related sound.

In the sixth pattern, the addition unit 355 sets the internal environmental sound to a higher volume than the vehicle-related sound, and adds the internal environmental sound and the vehicle-related sound.

In the sixth pattern, when the conversation content acquired by the third acquisition unit 353 is content related to the vehicle 3, the addition unit 355 sets the vehicle-related sound to be added to a higher volume than the vehicle-related sound to be added when the conversation content is not content related to the vehicle 3.

### Seventh Pattern

A seventh pattern is a pattern in which the sound to be added is the external environmental sound, the internal environmental sound, and the vehicle-related sound.

In the seventh pattern, the addition unit 355 sets the internal environmental sound to a higher volume than the vehicle-related sound and the external environmental sound, and adds the external environmental sound, the internal environmental sound, and the vehicle-related sound.

In the seventh pattern, when the identification unit 354 has identified the region of interest, the addition unit 355 sets, among the plurality of external environmental sounds to be added, the external environmental sound corresponding to the region of interest to a higher volume than the external environmental sound corresponding to a region other than the region of interest.

In the seventh pattern, when the conversation content acquired by the third acquisition unit 353 is content related to the external environmental sound such as “weather” or “scenery,” the addition unit 355 sets the external environmental sound to be added to a higher volume than the external environmental sound to be added when the conversation content is not content related to the external environment.

In the seventh pattern, when the conversation content acquired by the third acquisition unit 353 is content related to the vehicle 3, the addition unit 355 sets the vehicle-related sound to be added to a higher volume than the vehicle-related sound to be added when the conversation content is not content related to the vehicle 3.

### 6. Other Embodiments

The above-described embodiment indicates merely one aspect and can be freely modified and applied.

In another embodiment, the viewer terminal 200B may output the external environmental sound such that the sound appears to be produced from a location corresponding to a source of the external environmental sound. In this case, the viewer terminal 200B includes, for example, a stereophonic speaker. For example, when the sea is visible on the right side in a movement direction while the vehicle 3 is traveling, the viewer terminal 200B outputs the sound of waves as the external environmental sound so that the viewer U can hear the sound of waves coming from the right side. For example, when vehicle 3 is traveling through trees and the sound of birds can be heard from the left side in the movement direction, the viewer terminal 200B outputs the sound of birds as the external environmental sound so that the viewer U can hear the bird sounds coming from the left side. For example, when the vehicle 3 is traveling through trees, the viewer terminal 200B outputs “the sound of wind passing through the trees” as the external environmental sound so that the viewer U can hear the sound from all directions.

In another embodiment, the “target object” may be an object other than raindrops, such as a forest, sea, lake, or factory. In the case of this other embodiment, the “target object-related sound” related to the “target object” may be the sound of the sea when the “target object” is the sea, a sound related to the sound of wind passing through the forest, birds chirping, or the sound of running water when the “target object” is a forest, the sound of factory equipment when the “target object” is a factory, or the sound of birds chirping or fish splashing when the “target object” is a lake. In the case of this other embodiment, the addition unit 355 determines whether the target object is present in the image obtained through capturing by the “capturing apparatus,” and adds the target object-related sound when the target object is depicted in the image. Note that the addition unit 355 may determine whether the target object is present in the image obtained by through capturing by the “capturing apparatus” based on a color difference, pattern matching, or the like, or may determine whether the target object is present in the image obtained through capturing by the “capturing apparatus” based on the position information of the vehicle 3.

In the above-described embodiment, the in-vehicle apparatus 30 adds the internal environmental sound, the external environmental sound, and the vehicle-related sound to the image to be streamed. In another embodiment, the streaming server 100 may add the internal environmental sound, the external environmental sound, and the vehicle-related sound. In the case of this configuration, the streaming server 100 receives, from the in-vehicle apparatus 30, the current position of the vehicle 3, the vehicle information relating to the vehicle 3 (the acceleration of the vehicle 3, the speed of the vehicle 3, whether the direction indicator has been operated, and the like), the detection result from the raindrop sensor, and the like. In the case of this configuration, the streaming server 100 acquires the internal environmental sound of the vehicle 3 and the external environmental sound of the vehicle 3 from the in-vehicle apparatus 30. In the case of this configuration, the second processor 150 functions as the identification unit 354, the addition unit 355, and the streaming unit 356, and the streaming server 100 adds the sound to the image streamed from the in-vehicle apparatus 30 and streams the image to which the sound has been added to the viewer terminal 200B.

In the above-described embodiment, the in-vehicle apparatus 30 adds the internal environmental sound, the external environmental sound, and the vehicle-related sound to the image to be streamed. In another embodiment, the viewer terminal 200B may add the internal environmental sound, the external environmental sound, and the vehicle-related sound. In the case of this configuration, the viewer terminal 200B receives, from the in-vehicle apparatus 30 via the streaming server 100, the current position of the vehicle 3, the vehicle information relating to the vehicle 3 (the acceleration of the vehicle 3, the speed of the vehicle 3, whether the direction indicator has been operated, and the like), the detection result from the raindrop sensor, and the like. In the case of this configuration, the second processor 150 functions as the identification unit 354, the addition unit 355, and the streaming unit 356, and the viewer terminal 200B adds the sound to the image to be output and outputs the content. In the case of this configuration, the third control section 270 adds the internal environmental sound, the external environmental sound, and the vehicle-related sound stored in the third memory 280.

In the above-described embodiment, the streaming unit 356 of the in-vehicle apparatus 30 uploads the content data to the streaming server 100 via the external communication I/F 31. In another embodiment, the streamer terminal 200A may upload the content data to the streaming server 100. More specifically, in this case, the streamer terminal 200A uploads, to the streaming server 100, the content data including the image captured by the camera included in the streamer terminal 200A and the speech input via the microphone included in the streamer terminal 200A.

The configuration of each unit of the streaming system 1 shown in FIGS. 4 and 9 is merely an example, and a specific implementation form thereof is not particularly limited. In other words, it is not necessarily required that separate pieces of hardware be provided for the respective components, and the functions of the respective components may be realized by a single processor executing a program. Some functions realized by software in the above-described embodiment may be realized by hardware, or alternatively, some functions realized by hardware may be realized by software.

The step units of the operations shown in FIGS. 10 and 11 are divided in accordance with their main processing content, and the present invention is not limited by the manner in which the processing units are divided or by the names assigned to those processing units. One step unit may be divided into a greater number of step units in accordance with the processing content. One step unit may be divided so as to include a greater amount of processing. The order of these steps may be rearranged as appropriate so as not to impede the gist of the present invention.

### 7. Configurations Supported by Above Embodiment

The above embodiment supports the following configurations.

### (Configuration 1)

A streaming system including: a streaming unit configured to stream an image obtained through capturing by a capturing apparatus provided in a vehicle; a terminal apparatus provided in a location other than the vehicle and configured to display the streamed image; and an addition unit configured to add sound to the image, wherein the addition unit adds external environmental sound of the vehicle based on position information of the vehicle, and the terminal apparatus displays the image and outputs the external environmental sound added to the image.

According to the streaming system of configuration 1, a viewer of the image can view the image together with the external environmental sound suitable for a position of the vehicle. Therefore, the viewer of the image can more fully experience the sensation of riding in the vehicle.

### (Configuration 2)

A streaming system including: a streaming unit configured to stream an image obtained through capturing by a capturing apparatus provided in a vehicle; a terminal apparatus provided in a location other than the vehicle and configured to display the streamed image; and an addition unit configured to add sound to the image, wherein when a target object related to the sound added to the image is present outside of the vehicle, the addition unit adds target object-related sound being sound related to the target object as external environmental sound of the vehicle, and the terminal apparatus displays the image and outputs the target object-related sound added to the image.

According to the streaming system of configuration 2, it is possible to view the image together with the sound related to the target object when the target object is present outside of the vehicle. Therefore, a viewer of the image can more fully experience the sensation of riding in the vehicle.

### (Configuration 3)

The streaming system according to configuration 2, wherein the target object is a raindrop, and the target object-related sound is sound of rain.

According to the streaming system of configuration 3, the viewer of the image can view the image together with the sound of rain when it is raining outside of the vehicle. Therefore, the viewer of the image can more fully experience the sensation of riding in the vehicle.

### (Configuration 4)

The streaming system according to any one of the configurations 1 to 3, wherein the addition unit further adds engine sound to the image, based on vehicle information relating to the vehicle during driving, and the terminal apparatus further outputs the engine sound added to the image.

According to the streaming system of configuration 4, the viewer of the image can view the image together with the engine sound. Therefore, the viewer of the image can more fully experience the sensation of riding in the vehicle.

### (Configuration 5)

The streaming system according to any one of configurations 1 to 4, including a first acquisition unit configured to acquire the external environmental sound via an external microphone provided on the vehicle, wherein the addition unit adds the acquired external environmental sound acquired by the first acquisition unit.

According to the streaming system of configuration 5, the viewer of the image can view the image together with the actual external environmental sound. Therefore, the viewer of the image can more fully experience the sensation of riding in the vehicle.

### (Configuration 6)

The streaming system according to any one of configurations 1 to 5, including a second acquisition unit configured to acquire internal environmental sound of the vehicle via an internal microphone provided in the vehicle, wherein the addition unit sets the internal environmental sound acquired by the second acquisition unit to a higher volume than the external environmental sound, and adds the internal environmental sound, and the terminal apparatus further outputs the internal environmental sound added to the image.

According to the streaming system of configuration 6, the viewer of the image can hear the internal environmental sound at a higher volume than the external environmental sound. Generally, the internal environmental sound is heard at a higher volume than the external environmental sound inside a vehicle. Thus, according to the streaming system of configuration 6, the viewer of the image can more fully experience the sensation of riding in the vehicle.

### (Configuration 7)

The streaming system according to configuration 6, wherein when the second acquisition unit has not acquired the internal environmental sound for a predetermined amount of time or longer, the addition unit does not add the internal environmental sound to the image, and sets the external environmental sound to be added to a higher volume than the external environmental sound when adding the internal environmental sound to the image.

According to the streaming system of configuration 7, the viewer of the image can hear the external environmental sound at a higher volume when the internal environmental sound is not added. Generally, external the external environmental sound is heard at a higher volume inside a vehicle when the internal environmental sound is not present or quiet. Thus, the viewer of the image can more fully experience the sensation of riding in the vehicle.

### (Configuration 8)

The streaming system according to any one of configurations 1 to 7, including an identification unit configured to identify, based on a line of sight direction of a viewer that views the image on the terminal apparatus, a region of interest in the image that the viewer is paying attention to, wherein the addition unit sets the external environmental sound corresponding to the region of interest identified by the identification unit to a higher volume than the external environmental sound corresponding to a region other than the region of interest identified by the identification unit, and adds the external environmental sound corresponding to the region of interest identified by the identification unit.

According to the streaming system of configuration 8, the viewer of the image can hear the external environmental sound of the region of interest that the viewer is paying attention to at a higher volume than the external environmental sound that the viewer is not paying attention to.

### (Configuration 9)

The streaming system according to any one of configurations 1 to 8, including a third acquisition unit configured to acquire conversation content between a user of the terminal apparatus and an occupant of the vehicle, wherein the addition unit sets a volume of sound to be added, based on the conversation content acquired by the third acquisition unit.

According to the streaming system of configuration 9, the volume of the sound can be set taking into account the conversation content so that the viewer of the image can hear the sound. Therefore, it is possible to reduce interference in the conversation between the viewer of the image and the occupant of the vehicle by the sound to be added by the addition unit. Since the volume of the sound to be added is set, it is possible to prevent sound other than conversation being inaudible due to conversation, and to prevent not being able to experience the sensation of riding in the vehicle due to conversation.

### (Configuration 10)

A non-transitory computer-readable storage medium storing a program for causing a processor to function as: an addition unit configured to add sound to an image obtained through capturing by a capturing apparatus provided in a vehicle; and a streaming unit configured to stream, to a terminal apparatus, the image to which the sound has been added by the addition unit, wherein the addition unit adds external environmental sound of the vehicle based on position information of the vehicle.

According to the program of configuration 10, a viewer of the image can view the image together with the external environmental sound suitable for a position of the vehicle, since the terminal apparatus can output the image and the external environmental sound. Therefore, the viewer of the image can more fully experience the sensation of riding in the vehicle.

### (Configuration 11)

A non-transitory computer-readable storage medium storing a program for causing a processor to function as: an addition unit configured to add sound to an image obtained through capturing by a capturing apparatus provided in a vehicle; and a streaming unit configured to stream, to a terminal apparatus, the image to which the sound has been added by the addition unit, wherein when a target object related to the sound added to the image is present outside of the vehicle, the addition unit adds target object-related sound being sound related to the target object as external environmental sound of the vehicle.

According to the program of configuration 11, a viewer of the image can view the image together with the target object-related sound when the target object is present outside of the vehicle, since the terminal apparatus can output the image and the target object-related sound. Therefore, the viewer of the image can more fully experience the sensation of riding in the vehicle.

### (Configuration 12)

A streaming method including: a streaming step of streaming an image obtained through capturing by a capturing apparatus provided in a vehicle; a display step of displaying, by a terminal apparatus provided in a location other than the vehicle, the streamed image; and an addition step of adding sound to the image, wherein the addition step includes adding external environmental sound of the vehicle to the image based on position information of the vehicle, and the display step includes displaying the image and outputting the external environmental sound added to the image.

According to the streaming method of configuration 12, it is possible to achieve the same effects as the streaming system of configuration 1.

### (Configuration 13)

A streaming method including: a streaming step of streaming an image obtained through capturing by a capturing apparatus provided in a vehicle; a display step of displaying, by a terminal apparatus provided in a location other than the vehicle, the streamed image; and an addition step of adding sound to the image, wherein when a target object related to the sound added to the image is present outside of the vehicle, the addition step includes adding target object-related sound being sound related to the target object as external environmental sound of the vehicle, and the display step includes displaying the image and outputting the target object-related sound added to the image.

According to the streaming method of configuration 13, it is possible to achieve the same effects as the streaming system of configuration 1.

### REFERENCE SIGNS LIST

1 streaming system
3 vehicle
5 communication network
10 seat
11 backrest
12 headrest
13 headrest stay
30 in-vehicle apparatus
31 external communication I/F
32 first short-range wireless communication I/F
33 internal communication I/F
34 touch panel
35 speech processing unit
36 speaker
37 internal microphone
38 external microphone
39 sensor group
40 vehicle ECU
50 attachment
51 first holder
100 streaming server
110 network communication I/F
130 second control section
140 second memory
141 control program
143 user information database
145 stream management database
150 second processor
200A streamer terminal (capturing apparatus)
200B viewer terminal (terminal apparatus)
210 wireless communication I/F
220 second short-range wireless communication I/F
230 camera
240 display
250 microphone
260 speaker
270 third control section
280 third memory
281 OS
283 APP
290 third processor
310 input/output I/F
330 first control section
340 first memory
345 control program (program)
346 map data
347 location data
350 first processor (processor)
351 first acquisition unit
352 second acquisition unit
353 third acquisition unit
354 identification unit
355 addition unit
356 streaming unit
CA second region
IP viewpoint
LA first region
P1 image
RA third region
S streamer
U viewer

1. A streaming system comprising:
a streaming unit configured to stream an image obtained through capturing by a capturing apparatus provided in a vehicle;
a terminal apparatus provided in a location other than the vehicle and configured to display the streamed image; and
an addition unit configured to add sound to the image, wherein
the addition unit adds external environmental sound of the vehicle based on position information of the vehicle, and
the terminal apparatus displays the image and outputs the external environmental sound added to the image.

2. A streaming system comprising:
a streaming unit configured to stream an image obtained through capturing by a capturing apparatus provided in a vehicle;
a terminal apparatus provided in a location other than the vehicle and configured to display the streamed image; and
an addition unit configured to add sound to the image, wherein
when a target object related to the sound added to the image is present outside of the vehicle, the addition unit adds target object-related sound being sound related to the target object as external environmental sound of the vehicle, and
the terminal apparatus displays the image and outputs the target object-related sound added to the image.

3. The streaming system according to claim 2, wherein
the target object is a raindrop, and
the target object-related sound is sound of rain.

4. The streaming system according to claim 1, wherein
the addition unit further adds engine sound to the image, based on vehicle information relating to the vehicle during driving, and
the terminal apparatus further outputs the engine sound added to the image.

5. The streaming system according to claim 1, comprising a first acquisition unit configured to acquire the external environmental sound via an external microphone provided on the vehicle, wherein
the addition unit adds the acquired external environmental sound acquired by the first acquisition unit.

6. The streaming system according to claim 1, comprising a second acquisition unit configured to acquire internal environmental sound of the vehicle via an internal microphone provided in the vehicle, wherein
the addition unit sets the internal environmental sound acquired by the second acquisition unit to a higher volume than the external environmental sound, and adds the internal environmental sound, and
the terminal apparatus further outputs the internal environmental sound added to the image.

7. The streaming system according to claim 6, wherein
when the second acquisition unit has not acquired the internal environmental sound for a predetermined amount of time or longer, the addition unit does not add the internal environmental sound to the image, and sets the external environmental sound to be added to a higher volume than the external environmental sound when adding the internal environmental sound to the image.

8. The streaming system according to claim 1, comprising an identification unit configured to identify, based on a line of sight direction of a viewer that views the image on the terminal apparatus, a region of interest in the image that the viewer is paying attention to, wherein
the addition unit sets the external environmental sound corresponding to the region of interest identified by the identification unit to a higher volume than the external environmental sound corresponding to a region other than the region of interest identified by the identification unit, and adds the external environmental sound corresponding to the region of interest identified by the identification unit.

9. The streaming system according to claim 1, comprising a third acquisition unit configured to acquire conversation content between a viewer that views the image on the terminal apparatus and an occupant of the vehicle, wherein
the addition unit sets a volume of sound to be added, based on the conversation content acquired by the third acquisition unit.

10. A non-transitory computer-readable storage medium storing a program for causing a processor to function as:
an addition unit configured to add sound to an image obtained through capturing by a capturing apparatus provided in a vehicle; and
a streaming unit configured to stream, to a terminal apparatus, the image to which the sound has been added by the addition unit, wherein
the addition unit adds external environmental sound of the vehicle based on position information of the vehicle.

11. A non-transitory computer-readable storage medium storing a program for causing a processor to function as:
an addition unit configured to add sound to an image obtained through capturing by a capturing apparatus provided in a vehicle; and
a streaming unit configured to stream, to a terminal apparatus, the image to which the sound has been added by the addition unit, wherein
when a target object related to the sound added to the image is present outside of the vehicle, the addition unit adds target object-related sound being sound related to the target object as external environmental sound of the vehicle.

12. A streaming method comprising:
a streaming step of streaming an image obtained through capturing by a capturing apparatus provided in a vehicle;
a display step of displaying, by a terminal apparatus provided in a location other than the vehicle, the streamed image; and
an addition step of adding sound to the image, wherein
the addition step includes adding external environmental sound of the vehicle to the image based on position information of the vehicle, and
the display step includes displaying the image and outputting the external environmental sound added to the image.

13. A streaming method comprising:
a streaming step of streaming an image obtained through capturing by a capturing apparatus provided in a vehicle;
a display step of displaying, by a terminal apparatus provided in a location other than the vehicle, the streamed image; and
an addition step of adding sound to the image, wherein
when a target object related to the sound added to the image is present outside of the vehicle, the addition step includes adding target object-related sound being sound related to the target object as external environmental sound of the vehicle, and
the display step includes displaying the image and outputting the target object-related sound added to the image.
